(19) United States
(12) Patent Application Publication
(10) Pub. No.: US 2007/0032326 A1
(43) Pub. Date: Feb. 8, 2007

(54) Papermachine belt

(75) Inventor: Arved Westerkamp, Dettingen (DE)

Correspondence Address: VOITH FABRICS, 3040 BLACK CREEK ROAD, P.O. BOX 1411, WILSON, NC, 27893, US

(73) Assignee: Voith Patent GmbH

(21) Appl. No.: 11/495,127

(22) Filed: Jul. 28, 2006

(30) Foreign Application Priority Data
Aug. 6, 2005 (DE) 10 2005 037 162.0

(51) Int. Cl. F16G 1/00; F16G 5/00; F16G 9/00

(52) U.S. Cl. 474/263; 474/260; 474/237

(57) ABSTRACT

The invention relates to an endless belt having a top side for the transport of a fibrous web in a paper, board or tissue machine, and having an underside opposite the top side, the endless belt having a carrier structure and a polymer layer structure, and the polymer layer structure covering the carrier structure in order to form the top side and/or the underside of the endless belt. The polymer layer structure has material sections with a different hardness, which are arranged one above another between the top side and the underside and which overlap, at least in some sections.

### CROSS-REFERENCE TO RELATED APPLICATIONS

The present invention claims priority under 35 U.S.C. §119 of German Patent Application No. 10 2005 037 162.0 filed Aug. 6, 2005, the disclosure of which is expressly incorporated by reference herein in its entirety.

### BACKGROUND OF THE INVENTION

1. Field of the Invention

The invention relates to an endless belt, such as a transfer belt or center belt for transporting a fibrous web, in a paper, board or tissue machine. Such endless belts are used, for example, to transfer a fibrous web from one machine section to another machine section. Such endless belts can also be used for the purpose of guiding a fibrous web through one or more roll nips.

2. Discussion of Background Information

The endless belts disclosed by the prior art normally have a carrier structure, for example formed by a woven fabric, and a polymer layer structure formed from only one polymer material.

In applications in which, for example, there is cambering of the rolls, the cambering can lead to a non-uniform compressive behavior in the roll nip.

The disadvantage of the endless belts disclosed by the prior art consists in the fact that these are not suitable to compensate for a non-uniform pressure variation in the roll nip, that is to say in the CD direction.

### SUMMARY OF THE INVENTION

One object of the present invention is an endless belt with which a non-uniform pressure variation in the roll nip can be compensated for, at least partially. It is also an object of the present invention for a paper, board or tissue machine with improved productivity.

The known endless belt has a top side for the transport of a fibrous web in a paper, board or tissue machine, and an underside, the endless belt comprising a carrier structure and a polymer layer structure, and the polymer layer structure covering the carrier structure at least on one side in order to form the top side and/or the underside of the endless belt.

The endless belt according to the present invention is described in that the polymer layer structure comprises material sections with a different hardness, which are arranged one above another between the top side and the underside and which overlap, at least in some sections.

In this manner, material sections with a different hardness is to be understood to mean sections of the polymer structure which are formed from materials with different hardnesses.

By providing a polymer layer structure with material sections of different hardness arranged one above another and overlapping one another, a non-uniform pressure variation in a roll nip can be compensated for, at least partially, since damping of the pressure variation is effected by means of the softer material section(s).

Two or three or more material sections with a different hardness can also be arranged one above another and overlapping one another.

Advantageous refinements and developments of the invention are specified in the subclaims.

In order to produce a firm connection between the material sections with a different hardness, the latter are preferably welded or fused to one another two-dimensionally, at least in some sections. However, two-dimensional adhesive bonds are also conceivable.

According to an advantageous refinement of the invention, provision is made for the material sections of different hardness to be two-dimensional and to extend over at least part of the width of the layer structure. If the material sections extend only over part of the width, a different pressure variation can be compensated for zone by zone.

Furthermore, it is also possible for the material sections of different hardness to extend over the entire width of the layer structure.

The polymer layer structure preferably forms the top side of the endless belt. As a result of forming the top side by means of the polymer layer structure, an intrinsically closed, non-marking paper-side surface which is optimal for the release of the paper can be created at the same time, which, furthermore, has a reduced tendency to soiling.

According to a further refinement of the invention, provision can be made for the polymer layer structure to form the underside of the endless belt as an alternative to the top side, the underside being the side of the endless belt provided to touch the machine.

According to a further development of the invention, provision can be made for the layer structure to cover the carrier structure on both sides, that is to say for the polymer layer structure to form the top side and the underside of the endless belt.

Furthermore, provision can be made for the layer structure to envelop the carrier structure completely. In this case, the carrier structure is not only coated by the layer structure on both sides but enveloped completely by the latter, for example potted in the latter.

In general terms, the polymer layer structure can be sprayed or doctored onto the carrier structure, for example. The carrier structure can also be dipped in the still liquid polymer material. However, it is also conceivable for films of different hardness to be laminated onto one another. Furthermore, it is conceivable to produce the polymer layer structure from a suspension having polymer particles. In this connection, reference is made to WO 2004/085727 which, in this regard, is to be incorporated completely to its full extent in the disclosure content of this application.

To produce a polymer layer structure which envelops the carrier structure completely, for example casting processes, spraying processes, dipping processes, lick-up processes are conceivable.

Trials have shown that a non-uniform pressure variation can be compensated for effectively if a harder material section has a hardness of more than 90 Shore A, and a softer material section has a hardness of less than 90 Shore A.

Preferably, of a plurality of material sections arranged on one side relative to the carrier structure, at least one material section arranged further away from the carrier structure has a lower hardness than a material section arranged relatively closer thereto on the carrier structure.

If, for example, the polymer layer structure forms the top side of the endless belt, touching the paper, then this can mean that a material section arranged closer to the side of the endless belt touching the paper has a lower hardness then a material section arranged relatively further away from the side of the endless belt touching the paper.

Trials have shown that the compensation of a non-uniform pressure variation is particularly effective when material sections arranged one above another have a difference in hardness between 0.5% and 20%, preferably between 0.5% and 5%, relative to one another.

The carrier structure is preferably loadbearing.

In this case, the carrier structure can comprise, on their own or in combination, a woven fabric, a laid scrim, a knit, a loop knit, a nonwoven, a film, a spiralized structure.

Depending on the actual intended use of the endless belt, the polymer layer structure can be impermeable or permeable.

If the polymer layer structure is impermeable, this can be formed only of impermeable or of permeable and impermeable material sections.

At least one material section preferably comprises, on their own or in combination, epoxy resin, phenol, polyurethane.

Furthermore, it is conceivable for at least one material section to comprise an elastomer polymer material, in particular rubber.

Furthermore, the elastomer polymer material can comprise, for example, a thermoplastic elastomer, in particular ethylene vinyl acetate or thermoplastic polyurethane.

In order to influence, for example, the abrasion resistance of the machine side of the endless belt or the paper removal properties on the side touching the paper, it may be expedient if particulate and/or fibrous filler is embedded in the polymer layer structure, at least in some sections.

An extremely wide range of possibilities as to how the carrier structure can be connected to the polymer layer structure are conceivable. In order to produce a particularly durable connection between the carrier structure and the polymer layer structure, it is expedient if the carrier structure is embedded in the polymer layer structure, at least in some sections. This can be achieved, for example, when the carrier structure has an open surface, as is the case in a nonwoven, for example, and the polymer layer structure is cast onto the nonwoven.

The endless belt is preferably a transfer belt or a center belt. A center belt is a belt which closes open draws in the paper machine and which, in the process, itself runs through the functional elements of the paper machine, such as a press.

Furthermore, a paper, board or tissue machine is placed under protection, in which at least one machine section comprises an endless belt as claimed in one of the preceding claims, the machine section preferably being the press section or the drying section.

If, for example, the machine section is the press section, the endless belt is preferably led through at least one roll nip.

Furthermore, the press section can comprise a central roll and two mating rolls forming a roll nip with the central roll in each case, the endless belt wrapping around the central roll in such a way that it runs through both roll nips. An endless belt used in such a way is, for example, a center belt.

### BRIEF DESCRIPTION OF THE DRAWINGS

The present invention if further described in the detailed description which follows, in reference to the noted drawing by way of non-limiting example of exemplary embodiment of the present invention, and wherein:

FIG. 1 shows a cross-section in the CD direction of a first embodiment of an endless belt according to the invention, and

FIG. 2 shows a cross-section in the CD direction of a second embodiment of an endless belt according to the invention.

### DETAILED DESCRIPTION OF THE PRESENT INVENTION

The particulars shown herein are by way of example and for purposed of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

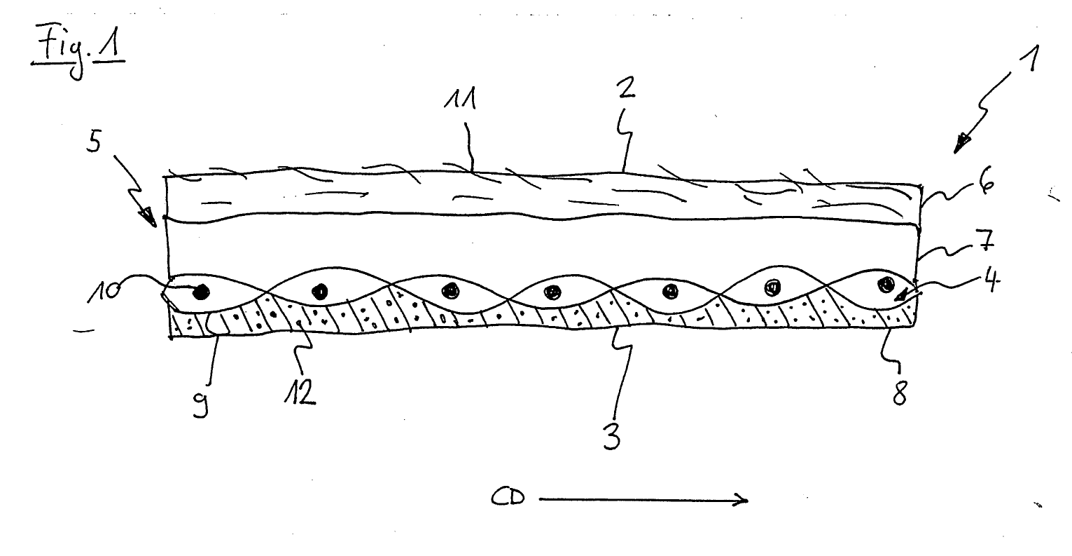

FIG. 1 shows a first embodiment of an endless belt 1 according to the invention, formed as a transfer belt, in cross-section in the CD direction.

The transfer belt 1 has a top side 2 for the transport of a fibrous web and an underside 3 which can be brought into contact with the paper machine. The transfer belt 1 illustrated is formed by a carrier structure 4 and a polymer layer structure 5, the polymer layer structure 5 for forming the top side 2 and the underside 3 of the transfer belt 1 covering the carrier structure 4 on both sides.

The polymer layer structure 5 comprises a first layer 6 forming the top side 2 of the transfer belt 1, a second layer 7 arranged between the first layer 6 and the carrier structure 4, and a third layer 8 forming the underside 3 of the transfer belt 1.

The first layer 6 is formed by a flat material section 6, the flat material section 6 comprising thermoplastic polyurethane and fibers 11 embedded therein, whose free ends project out of the layer 6 in some sections and thus extend partly on the top side 2 of the transfer belt 1. In this way, the paper transfer properties of the transfer belt 1 are improved. The layer 6 has a hardness of 75 Shore A.

The second layer 7 is formed by a flat material section 7 of polyurethane, which extends over the entire width of the polymer layer structure 5. Moreover, the material section 7 forming the layer 7 has a hardness of 95 Shore A.

Furthermore, the third layer 8 is formed by a flat material section 8. The material section 8 comprises a polymer material, such as phenol, in which particles 12 are embedded. The material section 8 extends over the entire width of the polymer layer structure 5. As a result of embedding the particles 12 in the phenol, the abrasion resistance of the transfer belt 1 is improved.

According to the invention, the polymer layer structure 5 comprises the material sections 6, 7 and 8, the material sections 6 and 7 having a hardness different from each other and these are arranged one above the other between the top side 2 and the underside 3 and overlap, at least in some sections.

Furthermore, of a plurality of material sections 6, 7 arranged on one side relative to the carrier structure 4, the material section 6 arranged further away from the carrier structure 4 has a lower hardness than the material section 7 arranged closer relative thereto on the carrier structure 6.

The top side 2 of the transfer belt 1 forms its envisaged paper-touching side. The layer structure 5 has been doctored onto the carrier structure 4.

The layers 6 and 7 are firmly connected to each other. Furthermore, the carrier structure 4 is in each case embedded in the layers 7 and 8, at least in some sections, so that, as a result, the carrier structure 4 is embedded in the polymer layer structure 5, at least in some sections.

The polymer layer structure 5 is wholly impermeable, all the layers 6, 7 and 8 being impermeable in the present exemplary embodiment.

Furthermore, the carrier structure 4 is loadbearing and formed as a woven fabric with weft threads 9 and warp threads 10.

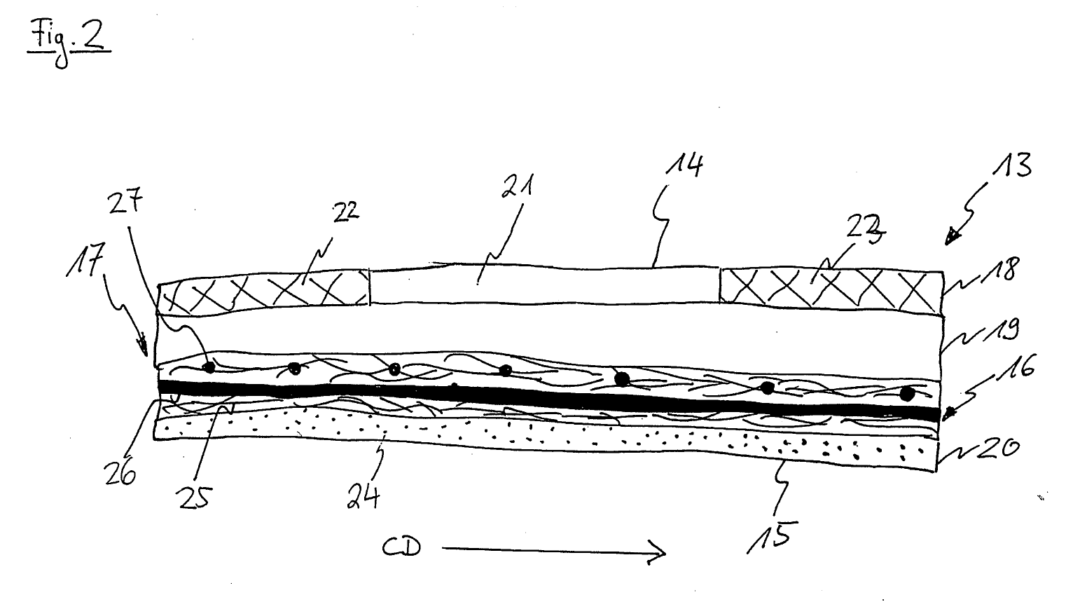

FIG. 2 shows a second embodiment of an endless belt 13 according to the invention, formed as a center belt, in cross-section in the CD direction.

The center belt 13 has a top side 14 for the transport of a fibrous web, and an underside 15. The center belt 13 illustrated is formed by a carrier structure 16 and by a polymer layer structure 17, the polymer layer structure 17 for forming the top side 14 and the underside 15 of the center belt 1 covering the carrier structure 16 on both sides.

The polymer layer structure 17 comprises a first layer 18 forming the top side 14, a second layer 19 arranged between the first layer 18 and the carrier structure 16, and a third layer 20 forming the underside 15.

The first layer 18 comprises a central flat material section 21 of thermoplastic polyurethane and two material sections 22 and 23 flanking the central material section 21 on both sides, which comprise a thermoplastic elastomer, such as ethylene vinyl acetate.

The material sections 21, 22 and 23 in each case extend over part of the width of the polymer layer structure 17. The two material sections 22 and 23 forming the edge region of the layer 18 have a hardness of 80 Shore A. The material section 21 forming the central region of the layer 18 has a hardness of 100 Shore A.

The second layer 19 is formed by a flat material section 19 of thermoplastic polyurethane, which extends over the entire width of the polymer layer structure 17. Moreover, the material section 19 forming the layer 19 has a hardness of 100 Shore A.

Furthermore, the third layer 20 is formed by a flat material section 20. The material section 20 comprises a polymer material, such as phenol, in which particles 24 are embedded. The material section 20 extends over the entire width of the polymer layer structure 17. As a result of embedding the particles 24 in the phenol, the abrasion resistance of the center belt 13 is improved.

According to the invention, the polymer layer structure 17 accordingly comprises material sections 22, 23 and 19 which have a hardness different from one another and which are arranged between the top side 14 and the underside 15 and in this case overlap, at least in some sections.

Furthermore, of a plurality of material sections 19, 22 and 23 arranged on one side relative to the carrier structure 16, the material sections 22 and 23 arranged further away from the carrier structure 16 have a lower hardness than the material section 19 arranged relatively closer thereto on the carrier structure 16.

The top side 14 of the center belt 14 forms its envisaged paper-touching side. The layer structure 17 has been poured onto the carrier structure 16.

The layers 18 and 19 are firmly connected to each other. Furthermore, the carrier structure 16 is in each case embedded in the layers 19 and 20, at least in some sections, so that, as a result, the carrier structure 16 is embedded in the polymer layer structure 17, at least in some sections.

The polymer layer structure 17 is wholly impermeable, all the layers 18, 19 and 20 being impermeable in the present exemplary embodiment.

Furthermore, the carrier structure 16 is loadbearing in the machine direction (MD direction) and transversely with respect to the machine direction (CD direction).

The carrier structure 16 comprises a fiber batt 25, in which a laid scrim having threads 27 oriented in the MD direction and threads 26 oriented in the CD direction is embedded.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An endless belt having a top side for the transport of a fibrous web in a paper, board or tissue machine, and having an underside opposite the top side, the endless belt comprising: a carrier structure and a polymer layer structure, and the polymer layer structure covering the carrier structure to form at least one of the top side and the underside of the endless belt, wherein the polymer layer structure comprises at least one first material section and at least one second material section, wherein the first material section has a first hardness and the second material section has a second hardness, wherein the first and second material sections are arranged one above another between the top side and the underside and wherein the first and second material sections overlap.

2. The endless belt as claimed in claim 1, wherein the first and second material sections are two-dimensional and extend over at least part of the width of the layer structure.

3. The endless belt as claimed in claim 1, wherein the first and second material sections extend over the entire width of the layer structure.

4. The endless belt as claimed in claim 1, wherein the layer structure covers the carrier structure on both sides.

5. The endless belt as claimed in claim 4, wherein the layer structure envelops the carrier structure completely.

6. The endless belt as claimed in claim 1, wherein the first hardness has a hardness of more than approximately 90 Shore A, and a softer material section has a hardness of less than approximately 90 Shore A.

7. The endless belt as claimed in claim 1, wherein, of a plurality of first and second material sections arranged on one side relative to the carrier structure, at least one of the first and second material sections arranged further away from the carrier structure has a lower hardness than the material section arranged relatively closer thereto on the carrier structure.

8. The endless belt as claimed in claim 1, wherein the first and second material sections arranged one above another have a difference in hardness between at least one of 0.5% to 20%, and 0.5% to 5%.

9. The endless belt as claimed in claim 1, wherein the carrier structure is loadbearing.

10. The endless belt as claimed in claim 1, wherein the carrier structure comprises at least one of a woven fabric, a laid scrim, a knit, a loop knit, a nonwoven, a film, and a spiralized structure.

11. The endless belt as claimed in claim 1, wherein the polymer layer structure is impermeable.

12. The endless belt as claimed in claim 1, wherein the polymer layer structure is permeable.

13. The endless belt as claimed in claim 1, wherein at least one material section comprises at least one of epoxy resin, phenol and polyurethane.

14. The endless belt as claimed in claim 1, wherein at least one material section comprises an elastomer polymer material.

15. The endless belt as claimed in claim 14, wherein the elastomer polymer material comprises at least one of a thermoplastic elastomer, in particular ethylene vinyl acetate, thermoplastic polyurethane and rubber.

16. The endless belt as claimed in claim 1, wherein at least one of a particulate filler and a fibrous filler is embedded in at least some sections in the polymer layer structure.

17. The endless belt as claimed in claim 1, wherein the carrier structure is embedded in the polymer layer structure, at least in some sections.

18. The endless belt as claimed in claim 1, wherein the endless belt is one of a transfer belt or a center belt.

19. A paper, board or tissue machine in which at least one machine section comprises the endless belt of claim 1.

20. The paper, board or tissue machine as claimed in claim 19, wherein the machine section is one of a press section and a drying section.

21. The paper, board or tissue machine as claimed in claim 19, wherein the endless belt is led through at least one roll nip in at least one machine section.

22. The paper, board or tissue machine as claimed in claim 20, wherein the press section comprises a central roll and two mating rolls forming a roll nip with the central roll in each case, the endless belt wrapping around the central roll in such a way that it runs through both roll nips.
